(19) United States
(12) Patent Application Publication
(10) Pub. No.: US 2002/0074475 A1
(43) Pub. Date: Jun. 20, 2002

(54) Wire clamp wear indicator

(76) Inventor: William G. Nordvik, San Jose, CA (US)

Correspondence Address: Henneman & Saunders, 121 E. 11th Street, Tracy, CA, 95376, US

(21) Appl. No.: 09/747,025

(22) Filed: Dec. 20, 2000

(51) Int. Cl. F16M 13/00

(52) U.S. Cl. 248/542; 248/68.1; 248/71

(57) ABSTRACT

A wear sensing wire clamp (10, 10a, 10b, 10c ) for securing a wire bundle (22), wire cable (34), hydraulic hose (38), fiber optic cable (44), or the like, to an aircraft bulkhead (32) or other such surface. A dye tube (16) containing a dye (20) is interposed and secured between an encircling band (12) and the object to be secured. Vibration will wear through the dye tube (16) releasing the dye (20) and thereby alerting users to a problem situation before a catastrophic failure occurs.

### TECHNICAL FIELD

The present invention relates to the field of mechanical devices for holding and securing electrical wiring and components. The predominant current usage of the present inventive wire clamp wear indicator is in the securing of wire bundles and cables in aircraft, wherein there is a significant vibration problem and further wherein the result of a shorted or broken wire might be catastrophic.

### BACKGROUND ART

It is known in the art to secure wire bundles, electrical cables, and the like with encircling clamps which are usually secured with a single screw or bolt. Frequently, such clamps have a rubber like padding on the surface thereof which comes into contact with the wires, to reduce chaffing and cutting of the wires by the clamp.

It is also known in the art to provide some sort of indication of excessive wear. For example, it is known to provide a material in a substrate layer of brake pads to cause the pads to emit an audible signal when the pads are worn down to such layer.

To the inventor's knowledge, no effort has been made to provide a wear indicator to be used in relation to a wire clamp. One reason for this may be that the surface of a wire clamp which comes into contact with the wires is hidden from view during normal usage, and so a conventional visual indicator would not be useful.

It would be beneficial to have a method or means to alert mechanics to a condition wherein a wire clamp might potentially wear through a wire, wire bundle, or electrical cable. However, to the inventor's knowledge no such method or means has existed in the prior art. All prior efforts have been directed to preventing vibration damage, however no effective means has been produced to alert users when such efforts might be failing.

### DISCLOSURE OF INVENTION

Accordingly, it is an object of the present invention to provide a means to alert users when a wire clamp is vibrating against wires.

It is still another object of the present invention to provide a method and means for detecting potentially hazardous conditions where a wire bundle or cable is held in place by a clamp.

It is yet another object of the present invention to provide a wear indicator which can be readily observed.

It is still another object of the present invention to provide an indication of vibration wear which cannot be easily overlooked.

It is yet another object of the present invention to provide a method and means to alert users to vibration before catastrophic failure occurs.

Briefly, a known embodiment of the present invention is an encircling wire clamp for securing wire bundles, electrical cables, hydraulic hoses, and the like. An interior surface of the clamp is surfaced with a flexible hollow tube which is sealed at both ends. Within the tube is a dye which will be released if the tube is worn through to the hollow interior. The tube is made from a material which is somewhat softer than that used for wire insulation in automotive and aircraft applications. Therefore, not only does the tube provide a container for the dye, the inflated tube also provides better protection to the wires than conventional rubberized wire clamps. In some applications the dye may be iridescent or the like. In some applications the interior of the tube may be pressurized.

An advantage of the present invention is users are alerted to a vibration problem before wire insulation is worn through.

A further advantage of the present invention is that a vibration alert indicator is readily observable without the need for close inspection of each individual component.

Yet another advantage of the present invention is that electrical failures due to vibration are significantly reduced and/or prevented.

Still another advantage of the present invention is that vibration indicating wire clamps can be inexpensively produced and used.

These and other objects and advantages of the present invention will become clear to those skilled in the art in view of the description of modes of carrying out the invention, and the industrial applicability thereof, as described herein and as illustrated in the several figures of the drawing. The objects and advantages listed are not an exhaustive list of all possible advantages of the invention. Moreover, it will be possible to practice the invention even where one or more of the intended objects and/or advantages might be absent or not required in the application.

Further, those skilled in the art will recognize that various embodiments of the present invention may achieve one or more, but not necessarily all, of the above described objects and advantages. Accordingly, the listed advantages are not essential elements of the present invention, and should not be construed as limitations.

### BRIEF DESCRIPTION OF THE DRAWINGS

FIG. 1 is a perspective view of an improved wire clamp according to the present invention;

FIG. 2 is an elevational cross sectional view of a wire bundle enclosed within the improved wire clamp of FIG. 1;

FIG. 3 is a side elevational view of the improved wire clamp of FIGS. 1 and 2;

FIG. 4 is a front elevational view of a first alternate embodiment of the present inventive wear sensing wire clamp;

FIG. 5 is a front elevational view of a second alternate embodiment of the present inventive wear sensing wire clamp;

FIG. 6 is a front elevational view of a third alternate embodiment of the present inventive wear sensing wire clamp; and

FIG. 7 is a front elevational view of a fourth alternate embodiment of the present inventive wear sensing wire clamp.

### DETAILED DESCRIPTION OF THE INVENTION

This invention is described in the following description with reference to the Figures, in which like numbers represent the same or similar elements. While this invention is described in terms of modes for achieving this invention's objectives, it will be appreciated by those skilled in the art that variations may be accomplished in view of these teachings without deviating from the spirit or scope of the present invention.

The embodiments and variations of the invention described herein, and/or shown in the drawings, are presented by way of example only and are not limiting as to the scope of the invention. Unless otherwise specifically stated, individual aspects and components of the invention may be omitted or modified, or may have substituted therefore known equivalents, or as yet unknown substitutes such as may be developed in the future or such as may be found to be acceptable substitutes in the future. The invention may also be modified for a variety of applications while remaining within the spirit and scope of the claimed invention, since the range of potential applications is great, and since it is intended that the present invention be adaptable to many such variations.

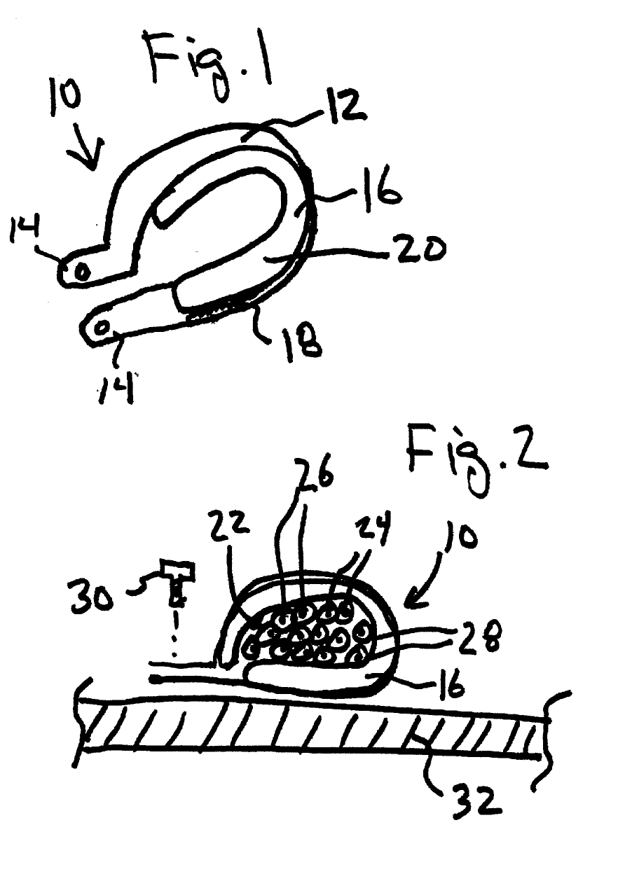

A known mode for carrying out the invention is a wear sensing wire clamp. The inventive wear sensing wire clamp is depicted in a perspective view in FIG. 1 and is designated therein by the general reference character 10. The wear sensing wire clamp 10 has an encircling band 12 having an attachment projection 14 on each end thereof. In this embodiment of the invention the encircling band 12 and the attachment projections 14 are formed from a single band of material. The material used in the presently described embodiment is steel, much like that of conventional wire clamps (not shown), although it is within the scope of the invention that the encircling band 12 and/or the attachment projections could be made from a plastic, composite, or other material.

In the embodiment described a dye tube 16 is affixed within the inner circumference of the encircling band 12 by an adhesive 18, although the invention is not restricted to this means of attachment. The dye tube 16 is a generally hollow tube which contains a liquid dye 20 and further which is sealed at each end thereof so as to contain the dye 20.

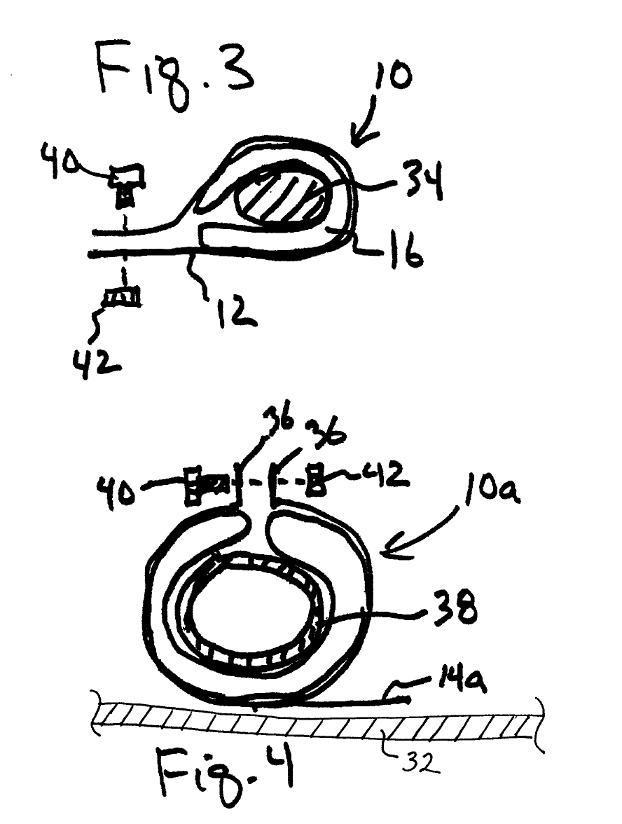

FIG. 2 is an elevational view of the wear sensing wire clamp 10 of FIG. 1 showing a wire bundle 22 (in cross section) having a plurality of individual electrical wires 24 enclosed within and contained by the wear sensing wire clamp 10. Each of the electrical wires 24 has a conductor 26 within an insulator 28. In the view of FIG. 2 is also shown an attachment screw 30 for attaching the wear sensing wire clamp 10 to a bulkhead 32.

The dye tube 16 can be made of essentially any material which will contain the dye 20 and further which is flexible enough to conform to the general shape of the encircling band 12 and further which is generally less wear resistant than the type of material from which the insulators 28 of the wires 24 are made. This last condition is desirable because any unwanted vibration of the wires 24 and/or the wear sensing wire clamp 10 in relation to the other will potentially cause both the insulators 28 and the dye tube 16 to wear through. According to the present invention, it is intended that the dye tube 16 wear through to release the dye 20 before the insulators 28 wear through, thereby preventing potential electrical shorts and/or any other problems which might be caused by exposure of the conductors 26 of the wires 24. In addition, a relatively soft dye tube 16 will assist in preventing wear of the insulators 28, thereby potentially preventing wear which might otherwise occur.

The dye 20 can be essentially any colored liquid which will be noticeable when and if it escapes from the dye tube. A brightly colored dye 20 will generally be preferable. Where electrical short circuits might be a problem, the dye 20 could be a nonconductive liquid. In the presently described embodiment 10 of the present invention, the dye 20 is iridescent such that it will glow when exposed to a black light. Therefore, an industrial type black light can be used to inspect the area of the inventive wear sensing wire clamp, and only the slightest bit of leaking dye 20 should be noticeable.

In the presently described embodiment of the invention, the dye 20 is sealed in the dye tube 16 at generally ambient air pressure where the wear sensing wire clamp 10 is assembled. Therefore, when the wear sensing wire clamp 10 is placed in an aircraft and the aircraft is at high altitude, the pressure within the dye tube 16 will be significantly greater than the ambient air pressure. Accordingly, if the dye tube 16 were to wear through, the dye 20 would escape aided by the pressure differential, and would spray about the general area of the wear sensing wire clamp 10, thereby making the fact that the dye 20 has escaped even more noticeable than it might otherwise be. It is within the scope of the invention to seal the dye 20 within the dye tube 16 at an even higher pressure such that this spraying effect might occur even when the wear sensing wire clamp 10 is used at sea level, or there about.

FIG. 3 is a side elevational view of the wear sensing wire clamp 10 of FIGS. 1 and 2. In the view of FIG. 3, the inventive wear sensing wire clamp 10 is being used to contain a wire cable 34.

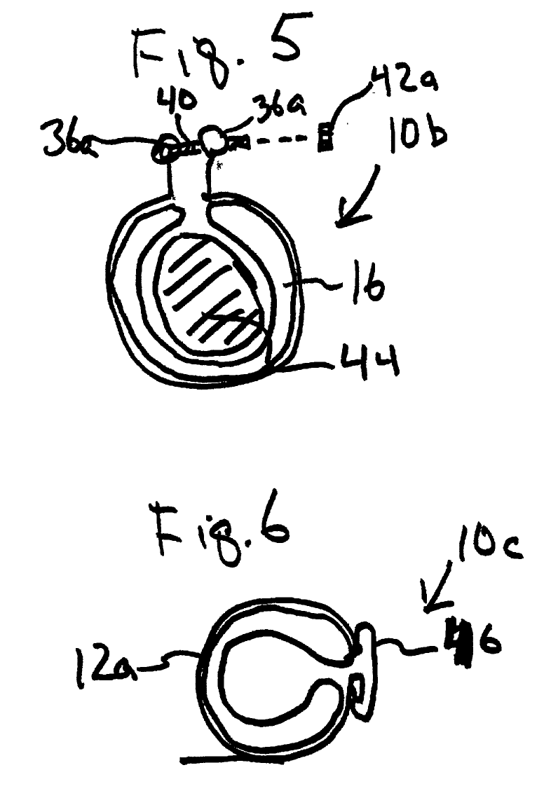

FIG. 4 is a front elevational view of a first alternate embodiment 10a of the inventive wear sensing wire clamp. This alternate embodiment illustrates a variation wherein an alternate attachment projection 14a is distinct from a pair of closure tabs 36. The closure tabs 36 are used, in the example illustrated in FIG. 4, for securing a hydraulic hose 38 therein, while the attachment projection 14a is used only to secure the first alternate sensing wire clamp 10a to the bulkhead 32. In the example of FIG. 4, the closure tabs 36 are secured together using a closure screw 40 and closure nut 42. It will be recognized that the functions of the attachment projection 14a and the closure tabs 36 are combined in the attachment projections 14 (FIG. 1) of the first described wear sensing wire clamp 10.

FIG. 5 is a front elevational view of a second alternate embodiment 10b of the wear sensing wire clamp. In the example of the second alternate embodiment 10b, a pair of closure loops 36a serve to close the wear sensing wire clamp 10b. An alternate closure screw 40a and alternate closure nut 42a secure a fiber optic cable 44 within the wear sensing wire clamp 10b, in this particular example.

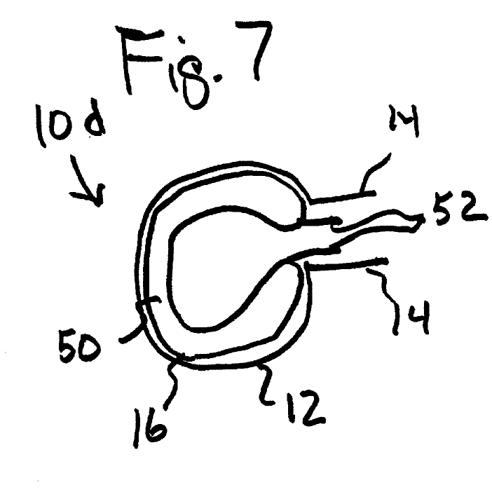

FIG. 6 is a front elevational view of a third alternate embodiment 10c of the inventive wear sensing wire clamp. In the example of the third alternate embodiment a closure latch assembly 46 is used to close an alternate encircling band 12a. Those skilled in the art will recognize that the closure latch assembly 36 is a conventional assembly such as is used to close some existing prior art clamps (not shown).

FIG. 7 is a front elevational view of a fourth alternate embodiment 10d of the present inventive wear sensing wire clamp. In this embodiment 10d of the invention, the dye tube 16 is filled with a conductive medium 50. In the example of FIG. 7, the conductive medium 50 is a fluid liquid, although it is within the scope of the invention that another type of fluid conductive medium, such as a powder, be used for the purpose. It is also within the scope of the invention that the conductive medium 50 be mixed with a dye 20 such as that previously discussed herein and/or that the conductive medium 50 be, itself, iridescent, of bright color, or otherwise compounded so as to be visually striking. In the fourth alternate embodiment 10d there are a pair of sensor terminals 52 positioned such that, when and if the conductive medium 50 were to escape from the dye tube 16, then an electric current might flow through the escaped conductive medium 50 between the sensor terminals 52. These features are provided so that external electrical and/or electronic monitoring devices (not shown) can be connected to the sensor terminals 52 so that escape of the conductive fluid 50 can be monitored from a remote location (such as the cockpit of an airplane).

Various modifications may be made to the invention without altering its value or scope. For example, the configurations shown in the several embodiments of the invention specifically described herein by no means is an exhaustive list of the types, shapes, and configurations of clamps which might be constructed according to the present invention. Furthermore, the objects specifically described as being secured in this disclosure is by no means an exhaustive list of the potential applications for the invention.

All of the above are only some of the examples of available embodiments of the present invention. Those skilled in the art will readily observe that numerous other modifications and alterations may be made without departing from the spirit and scope of the invention. Accordingly, the disclosure herein is not intended as limiting and the appended claims are to be interpreted as encompassing the entire scope of the invention.

### INDUSTRIAL APPLICABILITY

The inventive wear sensing wire clamp 10 is intended to be widely used in essentially any application wherein elongated objects need to be secured in place and further wherein there is a potential problem of wear caused by vibration of such elongated objects relative to the clamp 10. The wear sensing wire clamps 10 will be particularly useful where the consequences of a failure of the elongated object might be expensive and/or life threatening. An example of such application would be the where wire bundles, electrical cables, hydraulic lines, fiber optic cables, and the like are secured within an aircraft. Although mechanics regularly inspect such objects in an aircraft, wear between a clamp and objects secured therein may be hidden from view and may go unnoticed until there is a catastrophic failure. According to the present invention, not only are such problems made noticeable, they are marked so clearly and unequivocally that it would be difficult for even the most casual observer not to notice the problem.

Since the wear sensing wire clamps 10 of the present invention may be readily produced and used in like manner and instead of conventional wire clamps, and since the advantages as described herein are provided, it is expected that it will be readily accepted in the industry. For these and other reasons, it is expected that the utility and industrial applicability of the invention will be both significant in scope and long-lasting in duration.

I claim:

1. A clamp for securing a generally tubular object, comprising:
a band for generally encircling the object;
at least one closure projection for holding said band in place about the object;
a dye container interposed between said band and the object; and
a dye contained within said dye container.

2. The clamp of claim 1, wherein:
said dye container is a tube affixed to an inner circumference of said band.

3. The clamp of claim 1, wherein:
said dye is a liquid dye.

4. The clamp of claim 1, wherein:
said dye is an iridescent dye.

5. The clamp of claim 1, wherein:
said dye container is pressurized.

6. The clamp of claim 1, wherein:
said band is adapted to secure a wire bundle.

7. The clamp of claim 1, wherein:
said band is adapted to secure an electrical cable.

8. The clamp of claim 1, wherein:
said band is adapted to secure a hydraulic hose.

9. The clamp of claim 1, wherein:
said band is adapted to secure a fiber optic cable.

10. A clamp device for securing an elongated object to a fixed surface, the clamp device comprising:
a band for encircling the elongated object;
a closure apparatus for holding said band in place about the elongated object;
an indicator container interposed between said band and the elongated object; and
an indicator contained within said indicator container.

11. The clamp device of claim 10, wherein:
said indicator is a dye.

12. The clamp device of claim 10, wherein:
said indicator is an electrically conductive substance.

13. The clamp device of claim 10, wherein:
said indicator is a fluid.

14. The clamp device of claim 10, wherein:
said indicator is a powder.

15. The clamp device of claim 10, and further including:
at least one attachment apparatus for attaching the clamp to the generally fixed object.

16. The clamp device of claim 15, wherein:
the attachment apparatus includes a projection at each end of said band.

17. The clamp device of claim 15, wherein:
the attachment apparatus is said closure apparatus.

18. The clamp device of claim 10, wherein:
said band is adapted to be fixed to a surface within an aircraft.

19. The clamp device of claim 10, wherein:
said band is adapted to be fixed to an aircraft bulkhead.

20. The clamp device of claim 10, wherein:
said closure apparatus includes a projection at each end of said band.

21. The clamp device of claim 10, wherein:
said indicator container is an elongated tube.

22. The clamp device of claim 21, wherein:
said indicator container is affixed longitudinally generally along the length of an inner circumference of said band.

23. A clamp for securing wires, comprising:
a securing ring;
a dye container interposed between said securing ring and said wires; and
a dye contained within said dye container.

24. The clamp of claim 23, and further including:
a containment means for securing the wires within said securing ring.

25. The clamp of claim 23, and further including:
an attachment means for attaching the clamp to an external object.
